(19) United States
(12) Patent Application Publication
(10) Pub. No.: US 2016/0207819 A1
(43) Pub. Date: Jul. 21, 2016

(54) METHODS FOR LOCALIZED ANNEALING OF CHEMICALLY STRENGTHENED GLASS

(71) Applicant: CORNING INCORPORATED, Corning, NY (US)

(72) Inventors: Thomas Michael Cleary, Elmira, NY (US); James Gregory Couillard, Ithaca, NY (US); Kintu Odinga X Early, Painted Post, NY (US); Timothy Scott Huten, Big Flats, NY (US)

(73) Assignee: CORNING INCORPORATED, CORNING, NY (US)

(21) Appl. No.: 14/913,904

(22) PCT Filed: Aug. 21, 2014
(86) PCT No.: PCT/US14/52025

§ 371 Date: Feb. 23, 2016

Related U.S. Application Data
(60) Provisional application No. 61/869,973, filed on Aug. 26, 2013.

(51) Int. Cl. C03B 25/02; B32B 17/10; C03C 21/00

(52) U.S. Cl. CPC C03B 25/025; C03C 21/002; B32B 17/10036; B32B 17/10137

(57) ABSTRACT

A method of providing locally annealed regions for a glass article. The method includes providing a strengthened glass article having a first surface compressive stress and a first depth of layer of compressive stress, annealing the strengthened glass article to achieve a second surface compressive stress and a second depth of layer of compressive stress, and masking a portion of the glass article during the annealing step to achieve a third surface compressive stress and a third depth of layer of compressive stress in the masked portion. The glass article can be a laminate structure comprising a first glass layer, a second glass layer, and at least one polymer interlayer intermediate the first and second glass layers. The glass layers can include differing surface compressive stresses depths of layer of compressive stress.

This application claims the benefit of priority to U.S. Provisional Application No. 61/869,973 filed on Aug. 26, 2013, the content of which is incorporated herein by reference in its entirety.

### BACKGROUND

Glass laminates can be used as windows and glazing in architectural and vehicle or transportation applications, including automobiles, rolling stock, locomotive and airplanes. Glass laminates can also be used as glass panels in balustrades and stairs, and as decorative panels or coverings for walls, columns, elevator cabs, kitchen appliances and other applications. As used herein, a glazing or a laminated glass structure can be a transparent, semi-transparent, translucent or opaque part of a window, panel, wall, enclosure, sign or other structure. Common types of glazing that are used in architectural and/or vehicular applications include clear and tinted laminated glass structures.

Conventional automotive glazing constructions include two plies of 2 mm soda lime glass with a polyvinyl butyral (PVB) interlayer. These laminate constructions have certain advantages, including low cost and a sufficient impact resistance for automotive and other applications. However, because of their limited impact resistance and higher weight, these laminates exhibit poor performance characteristics, including a higher probability of breakage when struck by roadside debris, vandals and other objects of impact as well as well as lower fuel efficiencies for a respective vehicle.

In applications where strength is important (such as the above automotive application), the strength of conventional glass can be enhanced by several methods, including coatings, thermal tempering, and chemical strengthening (ion exchange). Thermal tempering is conventionally employed in such applications with thick, monolithic glass sheets, and has the advantage of creating a thick compressive layer through the glass surface, typically 20 to 25% of the overall glass thickness. The magnitude of the compressive stress is relatively low, however, typically less than 100 MPa. Furthermore, thermal tempering becomes increasingly ineffective for relatively thin glass, e.g., less than about 2 mm.

In contrast, ion exchange (IX) techniques can produce high levels of compressive stress in the treated glass, as high as about 1000 MPa at the surface, and is suitable for very thin glass. Ion exchange techniques, however, can be limited to relatively shallow compressive layers, typically on the order of tens of micrometers. This high compressive stress can result in very high blunt impact resistance, which might not pass particular safety standards for automotive applications, such as the ECE (UN Economic Commission for Europe) R43 Head Form Impact Test, where glass is required to break at a certain impact load to prevent injury. Conventional research and development efforts have been focused on controlled or preferential breakage of vehicular laminates at the expense of the impact resistance thereof.

For certain automobile glazings or laminates, e.g., windshields and the like, the materials employed therein must pass a number of safety criteria, such as the ECE R43 Head Form Impact Test. If a product does not break under the defined conditions of the test, the product would not be acceptable for safety reasons. This is one reason why windshields are conventionally made of laminated annealed glass rather than tempered glass. In such automotive applications having an upper limit on strength, thermal tempering is conventionally employed. Ion exchanged glass can be of interest in these applications because of its weight reduction, scratch and impact resistance capabilities thereof over thick thermally tempered glass while maintaining scratch and impact resistance over non-strengthened glass; however, the high impact resistance of traditionally ion exchanged glass can cause the respective laminate structure to fail safety standards such as ECE R43 headform impact test.

Thus, there is a need to provide high surface compressive stresses at the edges or other portions of a strengthened glass article while allowing lower surface compressive stresses at different portions of the glass article to thereby provide a product having enhanced durability while still allowing the glass to meet certain impact requirements.

### SUMMARY

The embodiments disclosed herein generally relate to methods for producing ion exchanged glass, e.g., glass having characteristics of moderate compressive stress, high depth of compressive layer, and/or desirable central tension. Additional embodiments provide automobile glazings or laminates having laminated, tempered glass.

In accordance with one or more embodiments herein, methods and apparatus provide for a thin glass article having a layer of surface compression from ion exchange techniques which enables scratch and impact resistance. The glass article can also exhibit a relatively high depth of compressive layer (DOL), making it resistant to environmental damage. Notably, the compressive stress (CS) at the glass surface in certain areas can be lower than in traditional ion exchanged glass, which allows the glass to pass automotive impact safety standards (such as the ECE R43 head form impact test) and is therefore suitable for automotive glazing applications.

Additional embodiments provide an ion exchange process for obtaining thin glass with moderate surface compressive stress and high depth of compressive layer by ion exchanging a glass article in KNO₃ at elevated temperatures, decorating regions of at least one surface of the article with a sodium-containing solution, e.g., NaNO₃, and annealing the glass article in air to reverse ion exchange the decorated glass regions, thereby locally lowering the surface compressive stress.

Further embodiments provide an ion exchange process for obtaining thin glass with moderate surface compressive stress and high depth of compressive layer by ion exchanging a glass article in KNO₃ at elevated temperatures to create a high depth of compressive layer and then annealing the glass article in air to further increase the depth of compressive layer while lowering the surface compressive stress and the central tension. During the annealing step the glass edges can be insulated and/or cooled to reduce the heat transfer and thus the reduction in surface compressive stress.

In some embodiments, a method of providing locally annealed regions for a glass article is provided. The method includes providing a strengthened glass article having a first surface compressive stress and a first depth of layer of compressive stress, annealing the strengthened glass article to achieve a second surface compressive stress and a second depth of layer of compressive stress, and masking a portion of the glass article during the annealing step to achieve a third surface compressive stress and a third depth of layer of compressive stress in the masked portion.

In other embodiments, a laminate structure is provided having a first glass layer, a second glass layer, and at least one polymer interlayer intermediate the first and second glass layers where the first glass layer is comprised of a strengthened glass having a first portion with a first surface compressive stress and a first depth of layer of compressive stress and a second portion with a second surface compressive stress and a second depth of layer of compressive stress.

It is to be understood that both the foregoing general description and the following detailed description present embodiments of the present disclosure, and are intended to provide an overview or framework for understanding the nature and character of the claimed subject matter. The accompanying drawings are included to provide a further understanding of the present disclosure, and are incorporated into and constitute a part of this specification. The drawings illustrate various embodiments and together with the description serve to explain the principles and operations of the claimed subject matter.

### BRIEF DESCRIPTION OF THE DRAWINGS

For the purposes of illustration, there are forms shown in the drawings that are presently preferred, it being understood, however, that the embodiments disclosed and discussed herein are not limited to the precise arrangements and instrumentalities shown.

FIG. 1 is a flow diagram illustrating some embodiments of the present disclosure.

FIG. 2 is a flow diagram illustrating additional embodiments of the present disclosure.

FIG. 3 is a pictorial depiction of the method generally illustrated in FIG. 2 for a thin sheet of glass.

FIG. 4 is a cross sectional illustration of some embodiments of the present disclosure.

FIG. 5 is a perspective view of additional embodiments of the present disclosure.

FIG. 6 is a flow diagram illustrating additional embodiments of the present disclosure.

FIG. 7 is an exploded view of a thin sheet of glass sandwiched between two ring molds.

FIG. 8 is a plot of abraded ring-on-ring failure loads for as-drawn glass, after ion exchange, and after ion exchange followed by a post-ion exchange anneal in air.

FIG. 9 is a Weibull plot providing a comparison of four-point bend failure loads for glass after ion exchange, and after IOX followed by a post-ion exchange anneal in air.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other.

Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range. As used herein, the indefinite articles “a,” and “an,” and the corresponding definite article “the” mean “at least one” or “one or more,” unless otherwise specified.

The following description of the present disclosure is provided as an enabling teaching thereof and its best, currently-known embodiment. Those skilled in the art will recognize that many changes can be made to the embodiment described herein while still obtaining the beneficial results of the present disclosure. It will also be apparent that some of the desired benefits of the present disclosure can be obtained by selecting some of the features of the present disclosure without utilizing other features. Accordingly, those of ordinary skill in the art will recognize that many modifications and adaptations of the present disclosure are possible and can even be desirable in certain circumstances and are part of the present disclosure. Thus, the following description is provided as illustrative of the principles of the present disclosure and not in limitation thereof.

Those skilled in the art will appreciate that many modifications to the exemplary embodiments described herein are possible without departing from the spirit and scope of the present disclosure. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the foregoing description of exemplary or illustrative embodiments is provided for the purpose of illustrating the principles of the present disclosure and not in limitation thereof and can include modification thereto and permutations thereof.

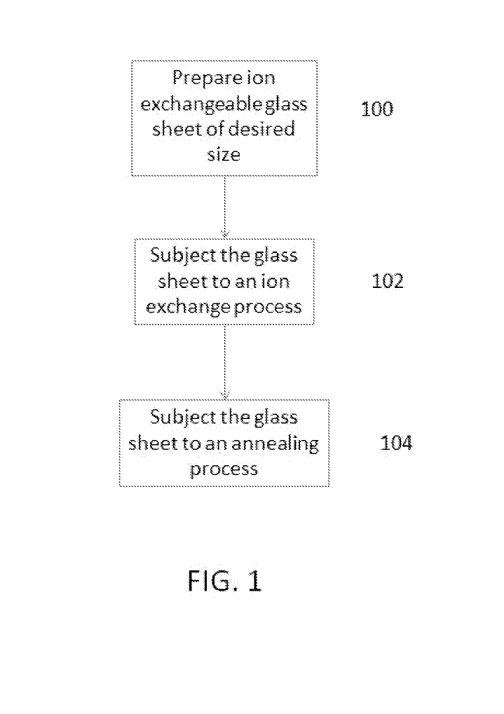

FIG. 1 is a flow diagram illustrating some embodiments of the present disclosure. With reference to FIG. 1, some embodiments include the application of one or more processes for producing a relatively thin glass sheet (on the order of about 2 mm or less) having certain characteristics, such as relatively moderate compressive stress (CS), relatively high depth of compressive layer (DOL), and/or moderate central tension (CT). The process includes preparing a glass sheet capable of ion exchange (step 100). The glass sheet can then be subjected to an ion exchange process (step 102), and thereafter the glass sheet can be subjected to an anneal process (step 104).

The ion exchange process 102 can involve subjecting the glass sheet to a molten salt bath including KNO₃, preferably relatively pure KNO₃ for one or more first temperatures within the range of about 400-500° C. and/or for a first time period within the range of about 1-24 hours, such as, but not limited to, about 8 hours. It is noted that other salt bath compositions are possible and would be within the skill level of an artisan to consider such alternatives. Thus, the disclosure of KNO₃ should not limit the scope of the claims appended herewith. Such an exemplary ion exchange process can produce an initial compressive stress (iCS) at the surface of the glass sheet, an initial depth of compressive layer (iDOL) into the glass sheet, and an initial central tension (iCT) within the glass sheet.

In general, after an exemplary ion exchange process, the initial compressive stress (iCS) can exceed a predetermined (or desired) value, such as being at or greater than about 500 MPa, and can typically reach 600 MPa or higher, or even reach 1000 MPa or higher in some glasses and under some processing profiles. Alternatively, after an exemplary ion exchange process, initial depth of compressive layer (iDOL) can be below a predetermined (or desired) value, such as being at or less than about 75 jam or even lower in some glasses and under some processing profiles. Alternatively, after an exemplary ion exchange process, initial central tension (iCT) can exceed a predetermined (or desired) value, such as above a predetermined frangibility limit of the glass sheet, which can be at or above about 40 MPa, or more particularly at or above about 48 MPa in some glasses.

If the initial compressive stress (iCS) exceeds a desired value, initial depth of compressive layer (iDOL) is below a desired value, and/or initial central tension (iCT) exceeds a desired value, this can lead to undesirable characteristics in a final product made using the respective glass sheet. For example, if the initial compressive stress (iCS) exceeds a desired value (reaching for example, 1000 MPa), then facture of the glass under certain circumstances might not occur. Although this may be counter-intuitive, in some circumstances the glass sheet should be able to break, such as in an automotive glass application where the glass must break at a certain impact load to prevent injury.

Further, if the initial depth of compressive layer (iDOL) is below a desired value, then under certain circumstances the glass sheet can break unexpectedly and under undesirable circumstances. Typical ion exchange processes can result in an initial depth of compressive layer (iDOL) being no more than about 40-60 μm, which can be less than the depth of scratches, pits, etc., developed in the glass sheet during use. For example, it has been discovered that installed automotive glazing (using ion exchanged glass) can develop external scratches reaching as deep as about 75 μm or more due to exposure to abrasive materials such as silica sand, flying debris, etc., within the environment in which the glass sheet is used. This depth can exceed the typical depth of compressive layer, which can lead to the glass unexpectedly fracturing during use.

Finally, if the initial central tension (iCT) exceeds a desired value, such as reaching or exceeding a chosen frangibility limit of the glass, then the glass sheet can break unexpectedly and under undesirable circumstances. For example, it has been discovered that a 4 inch×4 inch×0.7 mm sheet of Corning Gorilla® Glass exhibits performance characteristics in which undesirable fragmentation (energetic failure into a large number of small pieces when broken) occurs when a long single step ion exchange process (8 hours at 475° C.) was performed in pure KNO₃. Although a DOL of about 101 μm was achieved, a relatively high CT of 65 MPa resulted, which was higher than the chosen frangibility limit (48 MPa) of the subject glass sheet.

In accordance with one or more embodiments, however, after the glass sheet has been subject to ion exchange, the glass sheet can be subjected to an annealing process 104 by elevating the glass sheet to one or more second temperatures for a second period of time. For example, the annealing process 104 can be carried out in an air environment, can be performed at second temperatures within the range of about 400-500° C., and can be performed in a second time period within the range of about 4-24 hours, such as, but not limited to, about 8 hours. The annealing process 104 can thus cause at least one of the initial compressive stress (iCS), the initial depth of compressive layer (iDOL), and the initial central tension (iCT) to be modified.

For example, after the annealing process 104, the initial compressive stress (iCS) can be reduced to a final compressive stress (fCS) which is at or below a predetermined value. By way of example, the initial compressive stress (iCS) can be at or greater than about 500 MPa, but the final compressive stress (fCS) can be at or less than about 400 MPa, 350 MPa, or 300 MPa. It is noted that the target for the final compressive stress (fCS) can be a function of glass thickness as in thicker glass a lower fCS can be desirable, and in thinner glass a higher fCS can be tolerable.

Additionally, after the annealing process 104, the initial depth of compressive layer (iDOL) can be increased to a final depth of compressive layer (IDOL) at or above the predetermined value. By way of example, the initial depth of compressive layer (iDOL) can be at or less than about 75 μm, and the final depth of compressive layer (IDOL) can be at or above about 80 μm or 90 μm, such as 100 μm or more.

Alternatively, after the annealing process 104, the initial central tension (iCT) can be reduced to a final central tension (fCT) at or below the predetermined value. By way of example, the initial central tension (iCT) can be at or above a chosen frangibility limit of the glass sheet (such as between about 40-48 MPa), and the final central tension (fCT) can be below the chosen frangibility limit of the glass sheet. Additional examples for generating exemplary ion exchangeable glass structures are described in co-pending U.S. application Ser. No. 13/626,958, filed Sep. 26, 2012 and U.S. application Ser. No. 13/926,461, filed Jun. 25, 2013 the entirety of each being incorporated herein by reference.

As noted above the conditions of the ion exchange step and the annealing step can be adjusted to achieve a desired compressive stress at the glass surface (CS), depth of compressive layer (DOL), and central tension (CT). The ion exchange step can be carried out by immersion of the glass sheet into a molten salt bath for a predetermined period of time, where ions within the glass sheet at or near the surface thereof are exchanged for larger metal ions, for example, from the salt bath. By way of example, the molten salt bath can include KNO₃, the temperature of the molten salt bath can be within the range of about 400-500° C., and the predetermined time period can be within the range of about 1-24 hours, and preferably between about 2-8 hours. The incorporation of the larger ions into the glass strengthens the sheet by creating a compressive stress in a near surface region. A corresponding tensile stress can be induced within a central region of the glass sheet to balance the compressive stress.

By way of further example, sodium ions within the glass sheet can be replaced by potassium ions from the molten salt bath, though other alkali metal ions having a larger atomic radius, such as rubidium or cesium, can also replace smaller alkali metal ions in the glass. According to some embodiments, smaller alkali metal ions in the glass sheet can be replaced by Ag+ ions. Similarly, other alkali metal salts such as, but not limited to, sulfates, halides, and the like can be used in the ion exchange process.

The replacement of smaller ions by larger ions at a temperature below that at which the glass network can relax produces a distribution of ions across the surface of the glass sheet resulting in a stress profile. The larger volume of the incoming ion produces a compressive stress (CS) on the surface and tension (central tension, or CT) in the center region of the glass. The compressive stress is related to the central tension by the following approximate relationship:

$$CS = CT ( \frac{t - 2 DOL}{DOL} )$$

where t represents the total thickness of the glass sheet and DOL represents the depth of exchange, also referred to as depth of compressive layer.

Any number of specific glass compositions can be employed in producing the glass sheet. For example, ion-exchangeable glasses suitable for use in the embodiments herein include alkali aluminosilicate glasses or alkali aluminoborosilicate glasses, though other glass compositions are contemplated. As used herein, “ion exchangeable” means that a glass is capable of exchanging cations located at or near the surface of the glass with cations of the same valence that are either larger or smaller in size.

For example, a suitable glass composition comprises SiO₂, B₂O₃ and Na₂O, where (SiO₂+B₂O₃)≧66 mol. %, and Na₂O≧9 mol. %. In an embodiment, the glass sheets include at least 6 wt. % aluminum oxide. In a further embodiment, a glass sheet includes one or more alkaline earth oxides, such that a content of alkaline earth oxides is at least 5 wt. %. Suitable glass compositions, in some embodiments, further comprise at least one of K₂O, MgO, and CaO. In a particular embodiment, the glass can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for forming hybrid glass laminates comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≦(Li₂O+Na₂O+K₂O)≦20 mol. % and 0 mol. %≦(MgO+CaO)≦10 mol. %.

A still further example glass composition comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≦(Li₂O+Na₂O+K₂O)≦18 mol. % and 2 mol. %≦(MgO+CaO)≦7 mol. %.

In another embodiment, an alkali aluminosilicate glass comprises, consists essentially of, or consists of: 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

In a particular embodiment, an alkali aluminosilicate glass comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio

$$\frac{{Al}_{2} {O}_{3} + {B}_{2} {O}_{3}}{Σ modifiers} > 1 ,$$

where in the ratio the components are expressed in mol. % and the modifiers are alkali metal oxides. This glass, in particular embodiments, comprises, consists essentially of, or consists of: 58-72 mol. % SiO₂; 9-17 mol. % Al₂O₃; 2-12 mol. % B₂O₃; 8-16 mol. % Na₂O; and 0-4 mol. % K₂O, wherein the ratio

$$\frac{{Al}_{2} {O}_{3} + {B}_{2} {O}_{3}}{Σ modifiers} > 1.$$

In yet another embodiment, an alkali aluminosilicate glass substrate comprises, consists essentially of, or consists of: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; wherein 12 mol. %≦Li₂O+Na₂O+K₂O≦20 mol. % and 0 mol. %≦MgO+CaO≦10 mol. %.

In still another embodiment, an alkali aluminosilicate glass comprises, consists essentially of, or consists of: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≦SiO₂+B₂O₃+CaO≦69 mol. %; Na₂O+K₂O+B₂O₃+MgO+CaO+SrO>10 mol. %; 5 mol. %≦MgO+CaO+SrO≦8 mol. %; (Na₂O+B₂O₃)≦Al₂O₃≦2 mol. %; 2 mol. %≦Na₂O≦Al₂O₃≦6 mol. %; and 4 mol. %≦(Na₂O+K₂O)≦Al₂O₃≦10 mol. %. Additional compositions of exemplary glass structures are described in co-pending U.S. application Ser. No. 13/626,958, filed Sep. 26, 2012 and U.S. application Ser. No. 13/926,461, filed Jun. 25, 2013 the entirety of each being incorporated herein by reference.

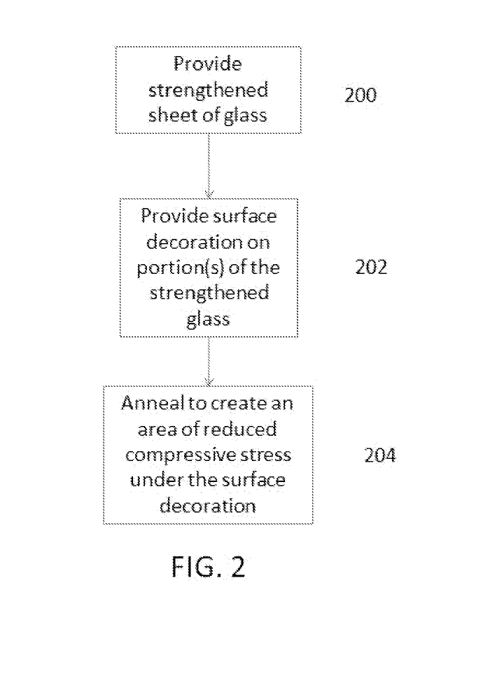

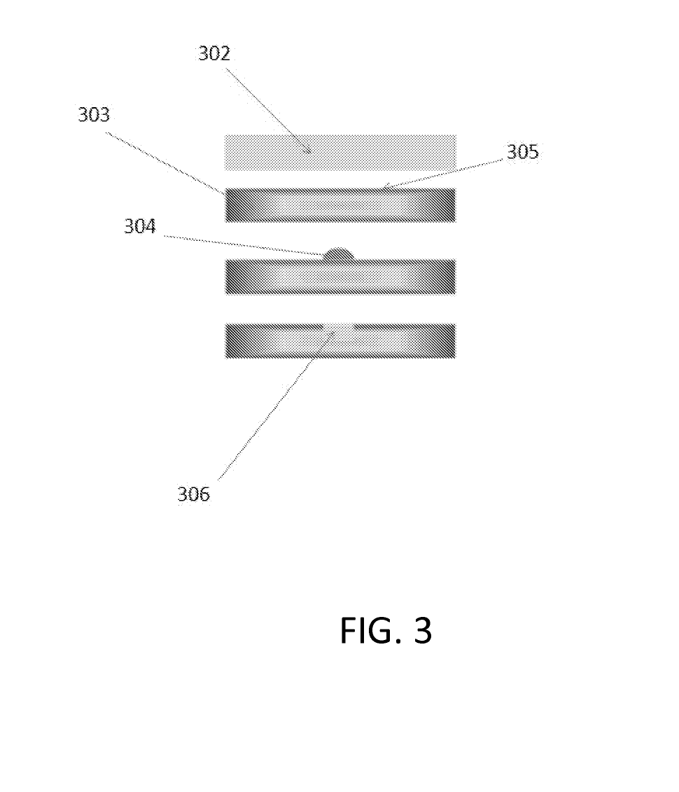

FIG. 2 is a flow diagram illustrating additional embodiments of the present disclosure. With reference to FIG. 2, these embodiments can include in step 200 providing an article of glass that has been chemically strengthened as discussed above. In step 202 a sodium-containing surface decoration such as, but not limited to, NaNO₃, can be placed on a portion(s) of the glass article. Any number of surfaces of a glass article can include this sodium-containing surface decoration, thus examples described herein referring to a single surface should not so limit the scope of the claims appended herewith. In step 204, the glass article can be annealed in a predetermined environment (e.g., air or the like) to reduce surface compressive stress in the area underlying the surface decoration, i.e., reverse ion exchanging the area underlying the surface decoration to provide a localized reduction in compressive stress and DOL. Of course, the conditions of each process step can be adjusted based on the desired compressive stress at the glass surface(s), desired depth of compressive layer, and desired central tension. FIG. 3 is a pictorial depiction of the method generally illustrated in FIG. 2 and described above for a thin sheet of glass. With reference to FIG. 3, a cross-sectional view of a thin sheet of glass is provided 302 before a strengthening process, e.g., an ion exchange process. After an ion exchange process, it can be observed that the glass article includes a predetermined depth of layer 303 of compressive stress as well as a surface compressive stress 305. A sodium-containing surface decoration 304 can then be provided on any portion of the glass article 302 whereby the glass article can be annealed in, for example, an air environment. The surface decoration 304 can then be removed resulting in a glass article having an area of lower compressive stress 306. Generally, air annealing can be less costly than ion exchanging due to simpler capital equipment and reduced consumable costs; however, the duration of these two steps can be balanced to optimize throughput.

In a non-limiting example specific to an automotive glazing application, 1100 mm×500 mm sheets of 0.7 mm glass were ion exchanged at 420° C. for 9.5 hours to reach a CS of 630 MPa and DOL of 57 μm. Two sheets were laminated using PVB and submitted for ECE (UN Economic Commission for Europe) R43 headform impact testing (dropping a 10 kg wooden headform from a height of 1.5 meters onto a glass sheet, which must fracture completely to pass the automotive impact safety standard). Due to the high strength of the panels none of the samples broke during the test, which would be considered a failure. Studies of similar sheets annealed after ion exchanging to lower their CS suggested 300 MPa or lower to be a desired maximum CS to ensure passing the test; however, for most other automotive aspects a high CS is desired. For example, certain automotive entities can require a minimum three point bend strength as an indicator that a glass article can survive a manufacturing process as well as survive in the field (such as closing a car door by pulling on a half open window). Subsequent experimental testing suggested that the glass article should then possess a minimum CS of around 440 MPa to pass this specification. It follows that glass articles cannot be formed from a uniform solution or process and simultaneously have a CS meeting both aforementioned requirements.

It was also determined that thermal annealing weakens the glass through stress relaxation and ion redistribution whereby stress relaxation accounts for less than 10% of the reduction in CS at temperatures around 400° C. The remaining reduction in CS was determined to be from potassium ions diffusing away from the respective glass surface. Further, as the glass is no longer submerged in a molten salt bath, the potassium ions can only diffuse in one direction, deeper into the glass. Thus, in some embodiments by adding a chemical sink for potassium on the glass surface (e.g., the sodium-containing surface decoration), the ions can be removed much faster and the resulting concentration of potassium at the glass surface will be lower than by annealing alone. Furthermore, it was discovered that if the chemical sink were to be applied selectively to the surface of a glass article, the resulting glass article would have regions of both higher and lower CS. Of course, the processes described herein can be suitable for a wide range of applications. One application of particular interest is for automotive glazing applications, whereby the process enables production of glass which can pass automotive impact safety standards, e.g., the glass center has regions with a CS less than 300 MPa allowing it to break under headform impact, whereas the edges and other regions thereof have CS greater than 440 MPa enabling resistance to environmental and mechanical damage. Other applications can be identified by those knowledgeable in the art.

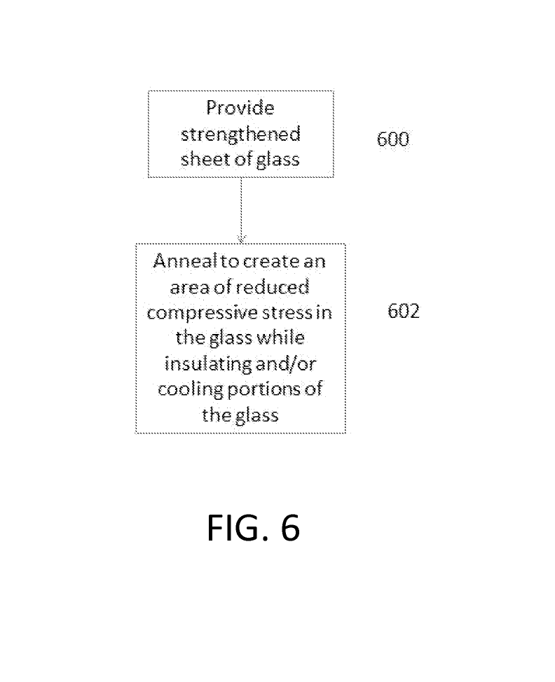

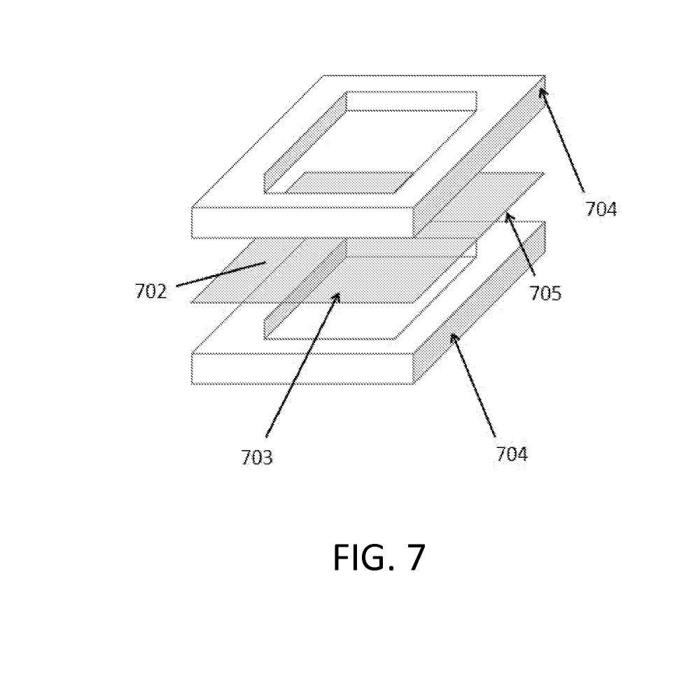

FIG. 6 is a flow diagram illustrating additional embodiments of the present disclosure. With reference to FIG. 6, these embodiments can include in step 600 providing an article of glass that has been strengthened as discussed above, e.g., by thermal-tempering, chemical-tempering, or the like. In the ion exchange step, the time and temperature can be based on known experimental response models. For example, 4 inch samples of glass can be treated at 460° C. in 100% KNO₃ for 6 hours to provide a CS of around 620 MPa and a DOL of 71.5 μm. Of course, such an example should not so limit the scope of the claims appended herewith as any number of various times and temperatures can be utilized in embodiments of the present disclosure. In step 602, the glass article can be annealed in a predetermined environment to further increase the DOL of CS in the article while lowering the CS to a desired target. During this step, however, the edges of the glass article can be insulated (see, e.g., FIG. 7) and/or cooled to reduce the heat transfer and thus the reduction in CS in these respective regions. It follows that after an ion exchange step (step 600), a respective glass article should have a lower CS than in parts which were ion exchanged to a shallower DOL; however, the CS level can still be significant, e.g., 620 MPa. An exemplary post-ion exchange anneal step can serve to further increase the DOL while lowering the CS and CT. For example, 6 hours at 455° C. can result in a CS of 227 MPa, DOL of 100 μm, and CT of 42 MPa. Thus, the CS can remain higher than that of bare or thermally tempered glass, and the resulting DOL can be greater than the depth of flaws typically found in some applications such as auto glazing.

Of course, the conditions of each process step depicted in FIG. 6 and described above can be adjusted based on the desired compressive stress at the glass surface(s), desired depth of compressive layer, and desired central tension. Generally, air annealing can be less costly than ion exchanging steps due to simpler capital equipment and reduced consumable costs; however, the duration of these two steps can be balanced to optimize throughput. As noted above, an exemplary glass article can be insulated and/or cooled to reduce heat transfer and the reduction in CS in a desired region. FIG. 7 is an exploded view of a thin sheet of glass sandwiched between two ring molds. With reference to FIG. 7, an exemplary sheet of ion exchanged thin glass 702 can be placed between two ring molds 704 made from insulating material. During the annealing process or step (step 602), the insulating material acts to prevent the annealing of the covered or masked sections 703 of the glass 702. Exemplary insulating blocks or molds 704 should be comprised of materials and/or have sufficient mass to slow the heating of the glass 702. The geometry of exemplary blocks or molds can be selected to protect the entire perimeter 705 (or other portions) of the glass to a desired depth, such as, but not limited to, about 2 cm to 3 cm. This added thermal mass can reduce the time during which the glass edges are at the peak temperature or can lower the maximum temperature to which they are exposed, which in turn can reduce the amount of stress relief and ion redistribution at those locations. In an alternative embodiment, the thermal blocks can be cooled with forced air to a temperature less than the oven internal temperature to further reduce the thermal exposure at the glass edge.

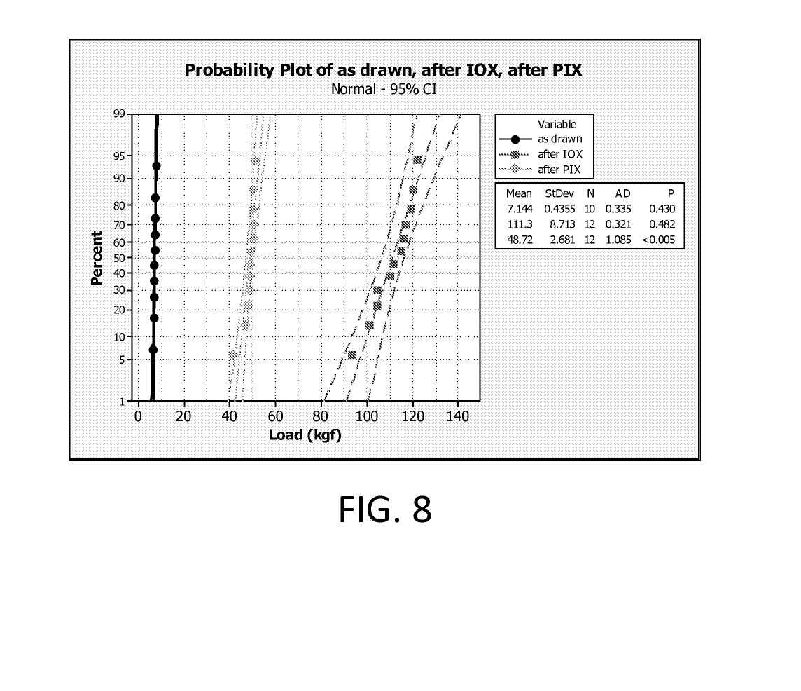

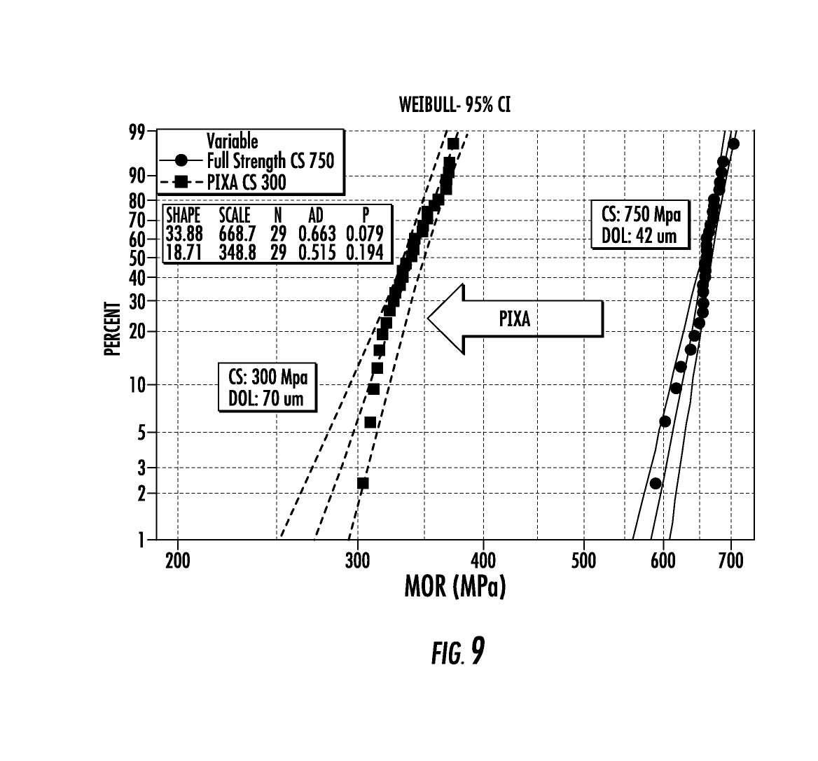

In a non-limiting example specific to an automotive glazing application, 1100 mm×500 mm sheets of 0.7 mm glass were ion exchanged at 420° C. for 9.5 hours to reach a CS of 630 MPa and DOL of 57 μm. Two sheets were laminated using PVB and submitted for ECE R43 headform impact testing. Due to the high strength of the panels none of the samples broke during the test, which would be considered a failure. Five similar sheets were annealed at 420° C. for 10 hours, resulting in a CS of 290 MPa and DOL of 92 μm. When laminated and subjected to impact testing, all five samples passed the regulatory test. Studies of similar sheets annealed after IX to lower their CS suggested 300 MPa or lower to be a desired maximum CS to ensure passing the test. FIG. 8 is a plot of abraded ring-on-ring failure loads for as-drawn glass, glass subjected to an ion exchange (465° C., 8 hours), and glass subjected to an ion followed by a post-ion exchange anneal in air (460° C., 5.5 hours). As depicted in FIG. 8, as drawn, ion exchanged and PIX glass are compared under similar failure modes. While a certain CS can be required to pass the ECE R43 headform test, for most other automotive aspects a high CS can be desired. For example, certain automotive entities can require a minimum three point bend strength as an indicator that a glass article can survive a manufacturing process as well as survival in the field (such as closing a car door by pulling on a half open window). Subsequent experimental testing suggested that the glass article should then possess a minimum CS of around 440 MPa to pass this specification. FIG. 9 is a Weibull plot providing a comparison of four-point bend failure loads for glass after ion exchange, and for ion exchange glass followed by a post-ion exchange anneal (PIXA) in air to lower the respective CS. It follows that glass articles cannot be formed from a uniform solution or process and simultaneously have CS meeting both aforementioned requirements. This can be achieved by thermally masking edges of a glass article as discussed above during an annealing step. As discussed above, during the annealing process or step (step 602), an insulating material can act to prevent the annealing of the covered or masked sections of a glass article. Exemplary insulating blocks or molds can be comprised of materials and/or have sufficient mass to slow the heating of the glass. Further, the geometry of exemplary blocks or molds can be selected to protect the entire perimeter (or other portions) of the glass to a desired depth. This added thermal mass can reduce the time during which the glass edges are at the peak temperature, or lower the maximum temperature to which they are exposed, which in turn can reduce the amount of stress relief and ion redistribution at those locations. In an alternative embodiment, the thermal blocks can be cooled with forced air to a temperature less than the oven internal temperature to further reduce the thermal exposure at the glass edge. In a further embodiment, infrared heat and/or localized conduction (e.g., hot plate, localized heating elements, etc.) can be employed to increase the annealing in the central portion of the glass article with reflective shields provided around the periphery of the glass article. In some embodiments, water cooled jackets can be employed in the place of forced air cooling around the periphery of the glass article. In an additional embodiment, conductive or convective heat sinks can be employed around the periphery of the glass article.

Exemplary processes can therefore create a thin glass article with a layer of surface compression, enabling higher retained strength and impact resistance over non-strengthened glass. The compressive stress at the glass surface can thus be lower at the glass center than at its edge(s) thereby making the glass resistant to environmental and mechanical damage, while enabling the glass to be broken under certain conditions. Exemplary processes described herein may be suitable for a range of applications. For example, in the non-limiting application of automotive glazing, the glass center can have a CS less than 300 MPa whereas the edges or other portions thereof have a CS greater than 440 MPa. Of course, other applications may be identified by those knowledgeable in the art.

Exemplary embodiments as described herein can also provide a glass article having improved retained strength and impact resistance versus non-strengthened glass, a glass article having higher compressive stress and is more compatible with thin glass versus thermal tempering alone, a glass article having a high depth of layer of compressive stress versus a standard, single step, ion exchange process, and a glass article providing cost advantages due to reduced cycle time and capital equipment requirements versus single step, ion exchange processes. Exemplary embodiments also provide a glass article providing cost advantages due to reduced cycle time and capital equipment requirements versus an ion exchange process in a mixed alkali bath, for example, 50% KNO₃+50% NaNO₃ (e.g., diffusion speed significantly increases the time to reach high DOL in embodiments of the present disclosure), a glass article having enhanced durability at the glass edges to withstand bending stresses during manufacture and use versus a uniform anneal to reduce CS, and/or a glass article providing for a faster reduction of CS and more control over the final stress pattern while retaining high scratch resistance on the non-treated areas versus annealing with thermal masking.

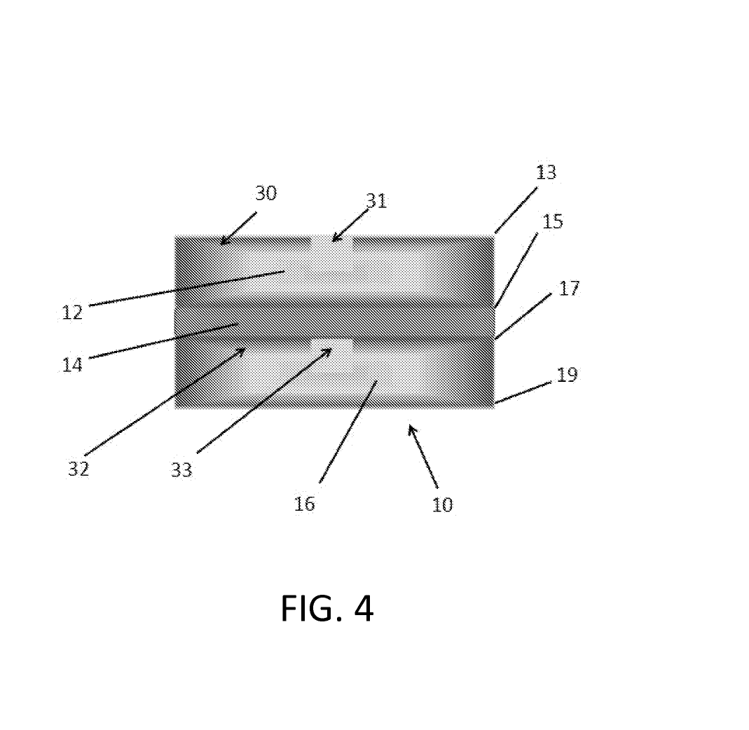

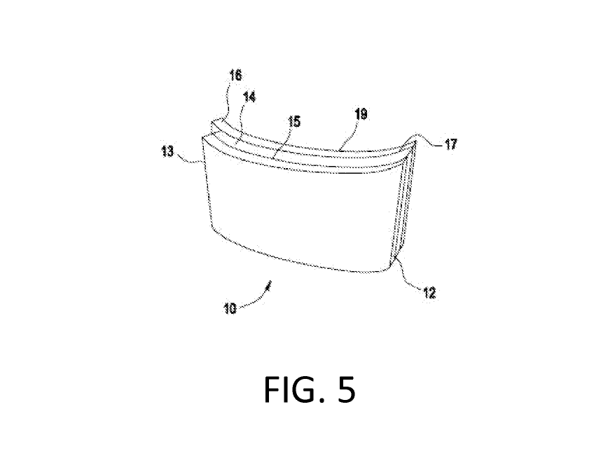

FIG. 4 is a cross sectional illustration of some embodiments of the present disclosure. FIG. 5 is a perspective view of additional embodiments of the present disclosure. With reference to FIGS. 4 and 5, an exemplary embodiment can include two layers of chemically strengthened glass, e.g., Gorilla® Glass, that have been heat treated, ion exchanged and annealed, as described above. Exemplary embodiments can possess a surface compression or compressive stress of approximately 300 MPa and a DOL of greater than about 60 microns in predetermined areas of the respective glass sheets 12, 16. In a preferred embodiment, a laminate 10 can be comprised of an outer layer 12 of glass having a thickness of less than or equal to 1.0 mm and having a residual surface CS level of greater than about 300 MPa with a predetermined DOL in a first predetermined area 30. In another embodiment the CS level of the outer layer 12 in the first predetermined area 30 is preferably greater than 440 MPa. In a second predetermined area 31, the outer layer 12 of glass can have a reduced or low compressive stress (e.g., the area masked by the sodium-containing surface decoration during an exemplary annealing step or the area not masked by a ring mold or other suitable thermal sink) in comparison to the first predetermined area 30. The laminate 10 also includes a polymeric interlayer 14 and an inner layer of glass 16 also having a thickness of less than or equal to 1.0 mm and having a residual surface CS level of greater than about 300 MPa with a predetermined DOLin a third predetermined area 32. In a fourth predetermined area 33, the inner layer 16 of glass can have a reduced or low compressive stress (e.g., the area masked by the sodium-containing surface decoration during an exemplary annealing step or the area not masked by a ring mold or other suitable thermal sink) in comparison to the third predetermined area 32. In another embodiment the CS level of the inner layer 16 in the third predetermined area 32 is preferably greater than 440 MPa. In one embodiment, an interlayer 14 can have a thickness of approximately 0.8 mm. Exemplary interlayers 14 can include, but are not limited to poly-vinyl-butyral or other suitable polymeric materials. In additional embodiments, any of the surfaces of the outer and/or inner layers 12, 16 can be acid etched to improve durability to external impact events. For example, in one embodiment, a first surface 13 of the outer layer 12 is acid etched and/or another surface 17 of the inner layer is acid etched. In another embodiment, a first surface 15 of the outer layer is acid etched and/or another surface 19 of the inner layer is acid etched. Such embodiments can thus provide a laminate construction that is substantially lighter than conventional laminate structures and which conforms to regulatory impact requirements.

In another embodiment of the present disclosure, at least one layer of thin but high strength glass can be used to construct an exemplary laminate structure. In such an embodiment, chemically strengthened glass, e.g., Gorilla® Glass can be used for the outer layer 12 and/or inner layer 16 of glass for an exemplary laminate 10. In another embodiment, the inner layer 16 of glass can be conventional soda lime glass, annealed glass, or the like. Exemplary thicknesses of the outer and/or inner layers 12, 16 can range in thicknesses from 0.55 mm to 1.5 mm to 2.0 mm or more. Additionally, the thicknesses of the outer and inner layers 12, 16 can be different in a laminate structure 10. Exemplary glass layers can be made by fusion drawing, as described in U.S. Pat. Nos. 7,666,511, 4,483,700 and 5,674,790, the entirety of each being incorporated herein by reference, and then chemically strengthening such drawn glass. Exemplary glass layers 12, 16 can thus possess a deep DOL of CS in predetermined areas and can present a high flexural strength, scratch resistance, edge strength, and impact resistance. Exemplary embodiments can also include acid etched or flared surfaces to increase the impact resistance and increasing the strength of such surfaces by reducing the size and severity of flaws on these surfaces. If etched immediately prior to lamination, the strengthening benefit of etching or flaring can be maintained on surfaces bonded to the inter-layer.

One embodiment of the present disclosure is directed to a laminate structure having a first glass layer, a second glass layer, and at least one polymer interlayer intermediate the first and second glass layers. The first glass layer can be comprised of a thin, chemically strengthened glass having a surface compressive stress of greater than about 300 MPa and a depth of layer (DOL) of CS greater than about 40 μm in a first predetermined area. The first glass layer can also include a second predetermined area having a surface compressive stress and/or a DOL less than the first predetermined area. In another embodiment, the second glass layer can be comprised of a thin, chemically strengthened glass having a surface compressive stress of greater than 300 MPa and a depth of layer (DOL) of CS greater than about 40 μm in a third predetermined area. The second glass layer can also include a fourth predetermined area having a surface compressive stress and/or a DOL less than the third predetermined area. Preferable surface compressive stresses of the first and/or second glass layers in the second and fourth predetermined areas, respectively, can be approximately 300 MPa. In some embodiments, the thicknesses of the first and/or second glass layers can be a thickness not exceeding 1.5 mm, a thickness not exceeding 1.0 mm, a thickness not exceeding 0.7 mm, a thickness not exceeding 0.5 mm, a thickness within a range from about 0.5 mm to about 1.0 mm, a thickness from about 0.5 mm to about 0.7 mm Of course, the thicknesses and/or compositions of the first and second glass layers can be different from each other. Additionally, the surface of the first glass layer opposite the interlayer can be acid etched, and the surface of the second glass layer adjacent the interlayer can be acid etched. Exemplary polymer interlayers include materials such as, but not limited to, poly vinyl butyral (PVB), polycarbonate, acoustic PVB, ethylene vinyl acetate (EVA), thermoplastic polyurethane (TPU), ionomer, a thermoplastic material, and combinations thereof.

Another embodiment of the present disclosure is directed to a laminate structure having a first glass layer, a second glass layer, and at least one polymer interlayer intermediate the first and second glass layers. The first and second glass layers can be comprised of a thin, chemically strengthened glass having a surface compressive stress of greater than about 300 MPa and a depth of compressive layer (DOL) of greater than about 40 μm in first predetermined areas of each respective glass layer. In second predetermined areas of the respective glass layers, a surface compressive stress and a DOL can be less than the first predetermined areas. Preferable surface compressive stresses of the first and/or second glass layers in these second predetermined areas can be approximately 300 MPa. In some embodiments, the thicknesses of the first and/or second glass layers can be a thickness not exceeding 1.5 mm, a thickness not exceeding 1.0 mm, a thickness not exceeding 0.7 mm, a thickness not exceeding 0.5 mm, a thickness within a range from about 0.5 mm to about 1.0 mm, a thickness from about 0.5 mm to about 0.7 mm. Of course, the thicknesses of the first and second glass layers can be different from each other. Additionally, the surface of the first glass layer opposite the interlayer can be acid etched, and the surface of the second glass layer adjacent the interlayer can be acid etched. In another embodiment, the surface of the first glass layer in contact with the interlayer can be acid etched, and the surface of the second glass layer opposite the interlayer can be acid etched. Exemplary polymer interlayers include materials such as, but not limited to, poly vinyl butyral (PVB), polycarbonate, acoustic PVB, ethylene vinyl acetate (EVA), thermoplastic polyurethane (TPU), ionomer, a thermoplastic material, and combinations thereof. The first or second glass layer can have a central tension (CT) that is below a predetermined frangibility limit.

Concerns related to damage levels of impact injuries to a vehicle occupant has required a relatively easier breakage for automotive glazing products. For example, in ECE R43 Revision 2, there is a requirement that, when the laminate is impacted from an internal object (by an occupant's head during a collision), the laminate should fracture so as to dissipate energy during the event and minimize risk of injury to the occupant. This requirement has generally prevented direct use of high strength glass as both plies of a laminate structure. It has been discovered through extensive headform testing that exemplary laminate structures according to embodiments of the present disclosure having one or more layers of chemically strengthened glass with a residual surface compressive stress level of about 250 MPa to about 350 MPa in a first predetermined area(s) and areas of less surface compressive stress, and with glass thicknesses of approximately 0.7 mm for each layer, consistently comply with these test requirements.

With continued reference to FIG. 5, another exemplary laminate structure 10 embodiment is illustrated having an outer layer 12 of glass with a thickness of less than or equal to 1.0 mm and having a residual surface CS level of between about 250 MPa to about 350 MPa with a DOL of greater than 40 microns in first predetermined areas, a polymeric interlayer 14, and an inner layer of glass 16 also having a thickness of less than or equal to 1.0 mm and having a residual surface CS level of between about 250 MPa to about 350 MPa with a DOL of greater than 40 microns in similar predetermined areas. As illustrated, the laminate structure 10 can be flat or formed to three-dimensional shapes by bending the formed glass into a windshield or other glass structure utilized in vehicles.

Embodiments of the present disclosure can thus provide an ability to reduce the strength of the glass in specific areas of a glass article, to make the article compliant with safety standards (such as head impact) while maintaining the full strength of the glass in other areas of the article (e.g., near the edges of the glass article). Additional embodiments also provide the advantage of localized annealing on one or both surfaces of a glass article.

In some embodiments, a method of providing locally annealed regions for a glass article is provided. The method includes providing a strengthened glass article having a first surface compressive stress and a first depth of layer of compressive stress, annealing the strengthened glass article to achieve a second surface compressive stress and a second depth of layer of compressive stress, and masking a portion of the glass article during the annealing step to achieve a third surface compressive stress and a third depth of layer of compressive stress in the masked portion. In additional embodiments, the second surface compressive stress can be less than the first surface compressive stress and the second depth of layer of compressive stress can be greater than the first depth of layer of compressive stress. Exemplary steps of masking can be, but are not limited to, providing an insulating material on the periphery of the glass article to slow the annealing of the periphery, cooling the insulating material with forced air, providing reflective shields around the periphery of the glass article to reflect heat from the heat source (when using a heat source to increase annealing in non-masked portions of the glass article), cooling the masked portions of the glass article using water cooled jackets, using conductive or convective heat sinks around the periphery of the glass article to slow the annealing of the periphery, and combinations thereof. In some embodiments, the third surface compressive stress can be greater than the second surface compressive stress and less than the first compressive stress. In other embodiments, the third depth of layer of compressive stress can be less than the second depth of layer of compressive stress and greater than the first depth of layer of compressive stress. An exemplary strengthened glass article can include one or more glass layers and an interlayer. Additionally, an exemplary strengthened glass article can include a chemically strengthened glass layer, a thermally strengthened glass layer, or a combination thereof. In yet a further embodiment, the step of masking further can include using a sodium-containing solution to remove potassium ions from the masked portion. In such an embodiment, the third surface compressive stress can be less than both the second and first surface compressive stresses. Additionally in such an embodiment, the third depth of layer of compressive stress can be less than the second depth of layer of compressive stress.

In other embodiments, a laminate structure is provided having a first glass layer, a second glass layer, and at least one polymer interlayer intermediate the first and second glass layers where the first glass layer is comprised of a strengthened glass having a first portion with a first surface compressive stress and a first depth of layer of compressive stress and a second portion with a second surface compressive stress and a second depth of layer of compressive stress. Exemplary strengthened glass of the first and/or second layers can be chemically strengthened glass or thermally strengthened glass. In some embodiments, the first surface compressive stress can be greater than about 300 MPa and the first depth of layer of compressive stress is greater than about 40 μm. In such embodiments, the second surface compressive stress can also be greater than the first surface compressive stress and the second depth of layer of compressive stress can also be less than the first depth of layer of compressive stress. In additional embodiments, the second glass layer can be comprised of a strengthened glass having a third portion with a third surface compressive stress and a third depth of layer of compressive stress and a fourth portion with a fourth surface compressive stress and a fourth depth of layer of compressive stress. In some embodiments, the third surface compressive stress can be greater than about 300 MPa and the third depth of layer of compressive stress can be greater than about 40 μm. In such embodiments, the fourth surface compressive stress can also be greater than the third surface compressive stress and the fourth depth of layer of compressive stress can also be less than the third depth of layer of compressive stress. In some embodiments, the first and third surface compressive stresses can be different and the first and third depth of layer of compressive stresses can also be different. Exemplary thicknesses of the first and second glass layers can be, but are not limited to, a thickness not exceeding 1.5 mm, a thickness not exceeding 1.0 mm, a thickness not exceeding 0.7 mm, a thickness not exceeding 0.5 mm, a thickness within a range from about 0.5 mm to about 1.0 mm, a thickness from about 0.5 mm to about 0.7 mm. Of course, the thicknesses of the first and second glass layers can be different and the composition of the first and second glass layers can be different. Exemplary materials for a polymer interlayer can be, but are not limited to, poly vinyl butyral (PVB), polycarbonate, acoustic PVB, ethylene vinyl acetate (EVA), thermoplastic polyurethane (TPU), ionomer, a thermoplastic material, and combinations thereof. An exemplary thickness for the interlayer can be approximately 0.8 mm.

While this description can include many specifics, these should not be construed as limitations on the scope thereof, but rather as descriptions of features that can be specific to particular embodiments. Certain features that have been heretofore described in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and can even be initially claimed as such, one or more features from a claimed combination can in some cases be excised from the combination, and the claimed combination can be directed to a subcombination or variation of a subcombination.

Similarly, while operations are depicted in the drawings or figures in a particular order, this should not be understood as requiring that such operations be performed in the particular order shown or in sequential order, or that all illustrated operations be performed, to achieve desirable results. In certain circumstances, multitasking and parallel processing can be advantageous.

As shown by the various configurations and embodiments illustrated in FIGS. 1-9, various embodiments for methods for localized annealing of chemically strengthened glass have been described.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof

1-30. (canceled)

31. A method of providing locally annealed regions for a glass article comprising:
(a) providing a strengthened glass article having a first surface compressive stress and a first depth of layer of compressive stress;
(b) annealing the strengthened glass article to achieve a second surface compressive stress and a second depth of layer of compressive stress; and
(c) masking a portion of the glass article during the annealing step to achieve a third surface compressive stress and a third depth of layer of compressive stress in the masked portion.
(d)

32. The method of claim 31 wherein the second surface compressive stress is less than the first surface compressive stress and the second depth of layer of compressive stress is greater than the first depth of layer of compressive stress.

33. The method of claim 31 wherein the step of masking further comprises providing an insulating material on the periphery of the glass article to slow the annealing of the periphery.

34. The method of claim 33 wherein the step of masking further comprises cooling the insulating material with forced air or cooling the insulating material using water cooled jackets.

35. The method of claim 31 wherein the step of annealing further comprises using a heat source to increase annealing in non-masked portions of the glass article and wherein the step of masking further comprises providing reflective shields around the periphery of the glass article to reflect heat from the heat source.

36. The method of claim 31 wherein the step of masking further comprises cooling the masked portions of the glass article using water cooled jackets.

37. The method of claim 31 wherein the step of masking further comprises using conductive or convective heat sinks around the periphery of the glass article to slow the annealing of the periphery.

38. The method of claim 31 wherein the third surface compressive stress is greater than the second surface compressive stress and less than the first compressive stress.

39. The method of claim 31 wherein the third depth of layer of compressive stress is less than the second depth of layer of compressive stress and greater than the first depth of layer of compressive stress.

40. The method of claim 31 wherein the strengthened glass article includes one or more glass layers and an interlayer.

41. The method of claim 31 wherein the strengthened glass article includes a chemically strengthened glass layer, a thermally strengthened glass layer, or a combination thereof.

42. The method of claim 31 wherein the step of masking further comprises using a sodium-containing solution to remove potassium ions from the masked portion.

43. The method of claim 42 wherein the third surface compressive stress is less than both the second and first surface compressive stresses, and wherein the third depth of layer of compressive stress is less than the second depth of layer of compressive stress.

44. A laminate structure comprising:
a first glass layer;
a second glass layer; and
at least one polymer interlayer intermediate the first and second glass layers,
wherein the first glass layer is comprised of a strengthened glass having a first portion with a first surface compressive stress and a first depth of layer of compressive stress and a second portion with a second surface compressive stress and a second depth of layer of compressive stress.

45. The laminate structure of claim 44 wherein the strengthened glass of the first layer is chemically strengthened glass or thermally strengthened glass.

46. The laminate structure of claim 44 wherein the first surface compressive stress is between about 250 MPa and about 350 MPa and the first depth of layer of compressive stress is greater than about 40 μm.

47. The laminate structure of claim 46 wherein the second surface compressive stress is greater than the first surface compressive stress and the second depth of layer of compressive stress is less than the first depth of layer of compressive stress.

48. The laminate structure of claim 44 wherein the second glass layer is comprised of a strengthened glass having a third portion with a third surface compressive stress and a third depth of layer of compressive stress and a fourth portion with a fourth surface compressive stress and a fourth depth of layer of compressive stress.

49. The laminate structure of claim 48 wherein the strengthened glass of the second layer is chemically strengthened glass or thermally strengthened glass, wherein the third surface compressive stress is between about 250 MPa and about 350 MPa and the third depth of layer of compressive stress is greater than about 40 μm, and wherein the fourth surface compressive stress is greater than the third surface compressive stress and the fourth depth of layer of compressive stress is less that the third depth of layer of compressive stress.

50. The laminate structure of claim 44 wherein the thicknesses of the first and second glass layers are selected from the group consisting of a thickness not exceeding 1.5 mm, a thickness not exceeding 1.0 mm, a thickness not exceeding 0.7 mm, a thickness not exceeding 0.5 mm, a thickness within a range from about 0.5 mm to about 1.0 mm, a thickness from about 0.5 mm to about 0.7 mm.
